(19) United States
(12) Patent Application Publication
(10) Pub. No.: US 2025/0200723 A1
(43) Pub. Date: Jun. 19, 2025

(54) IMAGE RELIGHTING WITH DIFFUSION MODELS

(71) Applicant: DOLBY LABORATORIES LICENSING CORPORATION

(72) Inventors: Jinlin LAI, Amherst, MA (US); Anustup Kumar Atanu CHOUDHURY, Campbell, CA (US); Guan-Ming SU, Fremont, CA (US)

(73) Assignee: DOLBY LABORATORIES LICENSING CORPORATION, (omitted)

(21) Appl. No.: 18/980,913

(22) Filed: Dec. 13, 2024

Related U.S. Application Data
(60) Provisional application No. 63/611,336, filed on Dec. 18, 2023.

(51) Int. Cl. G06T 5/60; G06T 5/50

(52) U.S. Cl. CPC G06T 5/60; G06T 5/50; G06T 2207/20081; G06T 2207/20084

(57) ABSTRACT

Methods and apparatus for relighting images. According to an example embodiment, inverse rendering is applied to an input image to extract a plurality of channels including an original lighting channel. A first neural network is used to determine a first latent feature corresponding to the input image based on a first set of channels including a shading channel generated using a replacement lighting channel. A second neural network is used to determine a second latent feature corresponding to the input image based on a different second set of channels including the replacement lighting channel. A relighted image is generated by propagating samples of a latent image map corresponding to the input image through a conditional diffusion model to which the first and second latent features are applied as first and second conditions.

### 1. CROSS-REFERENCE TO RELATED APPLICATIONS

This application claims priority to U.S. provisional application 63/611,336, filed Dec. 18, 2023 which is incorporated herein by reference in its entirety.

### 2. FIELD OF THE DISCLOSURE

Various example embodiments relate to image relighting.

### 3. BACKGROUND

Image relighting is a technique that involves changing the illumination settings of an image. For example, image relighting is used in computer graphics to create realistic and convincing images. With image relighting, it is possible to simulate different lighting conditions, which can be useful in various fields, with architecture and product design being just two examples. Image relighting can also be used in photography to create stunning and artistic images or to correct lighting issues, such as underexposure or overexposure. For example, a dull and poorly lit image can be transformed into a bright and vibrant one by adjusting the lighting settings via image relighting. In addition, image relighting can be used to remove shadows or to highlight certain areas within the image.

### BRIEF SUMMARY OF SOME SPECIFIC EMBODIMENTS

Disclosed herein are various embodiments of an image relighting pipeline employing a conditional diffusion model trained to generate an image conditioned on the albedo, normal, residual, and lighting channels extracted from the image with an inverse renderer. The lighting channel is represented by spherical harmonic coefficients, which are manipulated to change the lighting channel in a relatively straightforward manner. The denoising process of the conditional diffusion model is then used to generate a relighted image corresponding to the changed lighting channel. Various embodiments of the image relighting pipeline can beneficially be used to relight 2D outdoor-scene images including substantially coherent sky and shadow portions.

According to an example embodiment, provided is an image-relighting method comprising: extracting a plurality of channels by applying inverse rendering to an input image, the plurality of channels including an original lighting channel; with a first neural network, determining a first latent feature corresponding to the input image based on a replacement lighting channel and further based on a first subset of the plurality of channels not including the original lighting channel; with a second neural network, determining a second latent feature corresponding to the input image based on the replacement lighting channel and further based on a second subset of the plurality of channels not including the original lighting channel; and generating a relighted image by propagating samples of a latent image map corresponding to the input image through a conditional diffusion model to which the first and second latent features are applied as first and second conditions, respectively, the conditional diffusion model being implemented using a plurality of neural networks.

According to another example embodiment, provided is a training method comprising: extracting a plurality of channels by applying inverse rendering to an input image, the plurality of channels including a lighting channel; training a first neural network with a first decoder to determine a first latent feature corresponding to the input image based on a first subset of the plurality of channels not including the lighting channel; training a second neural network with a second decoder to determine a second latent feature corresponding to the input image based on a second subset of the plurality of channels including the lighting channel; training a conditional diffusion model to generate an output image by propagating therethrough samples of a latent image map corresponding to the input image with only a first condition being applied to the conditional diffusion model, the first condition being the first latent feature, the conditional diffusion model being implemented using a plurality of neural networks; and training the conditional diffusion model to generate the output image by propagating therethrough the samples of the latent image map corresponding to the input image with both the first condition and a second condition being applied thereto, the second condition being the second latent feature.

According to yet another example embodiment, provided is an image-relighting method comprising: extracting a plurality of channels by applying inverse rendering to an input image, the plurality of channels including an original lighting channel; with a first neural network, determining a first latent feature corresponding to the input image based on a replacement lighting channel and further based on a first subset of the plurality of channels not including the original lighting channel; and generating a relighted image by propagating samples of a latent image map corresponding to the input image through a conditional diffusion model to which the first latent feature is applied as a first condition, the conditional diffusion model being implemented using a plurality of neural networks.

According to yet another example embodiment, provided is an image-relighting method comprising: extracting a plurality of channels by applying inverse rendering to an input image, the plurality of channels including an albedo channel, a normal channel, an original lighting channel, and a residual channel; constructing a shading channel based on the normal channel and a replacement lighting channel; with a first downsampling network, determining a first latent feature corresponding to the input image based on the albedo channel, the normal channel, the residual channel, and the shading channel; with a second downsampling network, determining a second latent feature corresponding to the input image based on the normal channel and the replacement lighting channel; and generating a relighted image by propagating samples of a latent image map corresponding to the input image through a conditional diffusion model to which the first and second latent features are applied as first and second conditions, respectively, the conditional diffusion model being implemented using a plurality of neural networks.

According to another example embodiment, provided is a training method, comprising: extracting a plurality of channels by applying inverse rendering to an input image, the plurality of channels including an albedo channel, a normal channel, an original lighting channel, and a residual channel; constructing a shading channel based on the normal channel and a lighting channel; training a first downsampling network with a first up-sampling decoder to determine a first latent feature corresponding to the input image based on the albedo channel, the normal channel, the residual channel, and the shading channel; training a second downsampling network with a second up-sampling decoder to determine a second latent feature corresponding to the input image based on the normal channel and the lighting channel; training a conditional diffusion model to generate an output image by propagating therethrough samples of a latent image map corresponding to the input image with only a first condition being applied to the conditional diffusion model, the first condition being the first latent feature, the conditional diffusion model being implemented using a plurality of neural networks; and training the conditional diffusion model to generate the output image by propagating therethrough the samples of the latent image map corresponding to the input image with both the first condition and a second condition being applied thereto, the second condition being the second feature.

According to yet another example embodiment, provided is a non-transitory computer-readable medium storing instructions that, when executed by an electronic processor, cause the electronic processor to perform operations comprising any one of the above methods.

### BRIEF DESCRIPTION OF THE DRAWINGS

Other aspects, features, and benefits of various disclosed embodiments will become more fully apparent, by way of example, from the following detailed description and the accompanying drawings, in which:

FIG. 1 is a block diagram providing a high-level illustration of an image-relighting pipeline according to some examples.

FIG. 2 provides a visual representation of a set of basis functions that can be used to construct an approximation, with spherical harmonics, of the color and distribution of light according to some examples.

FIG. 3 is a block diagram illustrating a latent diffusion model according to some examples.

FIG. 4 is a block diagram illustrating forward diffusing and backward denoising processes used in the latent diffusion model of FIG. 3 according to some examples.

FIG. 5 is a block diagram illustrating a U-Net that can be used in the latent diffusion model of FIG. 3 according to some examples.

FIG. 6 is a block diagram illustrating a modification used to add conditions to an existing neural network according to some examples.

FIG. 7 is a block diagram illustrating the use of a ControlNet for a U-Net that is inside a stable diffusion model according to some examples.

FIG. 8 is a block diagram illustrating a surface encoder used in the image-relighting pipeline of FIG. 1 according to some examples.

FIG. 9 is a block diagram illustrating a shadow encoder used in the image-relighting pipeline of FIG. 1 according to some examples.

FIG. 10 is a block diagram illustrating an architecture of a downsampling network that can be used in either of the encoders of FIGS. 8-9 according to some examples.

FIG. 11 is a block diagram illustrating a computation flow for training the surface encoder of FIG. 8 at Stage 1 of the training process according to some examples.

FIG. 12 is a block diagram illustrating a computation flow for training the shadow encoder of FIG. 9 at Stage 1 of the training process according to some examples.

FIG. 13 is a block diagram illustrating an architecture of an upsampling decoder that can be used in either of the computation flows of FIGS. 11-12 according to some examples.

FIG. 14 is a block diagram illustrating an architecture for training the surface encoder of FIG. 8 at Stages 2 and 3 of the training process according to some examples.

FIGS. 15A-15E pictorially illustrate the training procedure applied to the image-relighting pipeline of FIG. 1 according to one example.

FIG. 16 is a block diagram illustrating a relighting pipeline according to some examples.

FIG. 17 is a block diagram illustrating a computing device used to implement the relighting pipeline of FIG. 16 according to some examples.

### DETAILED DESCRIPTION

Several approaches to image relighting can be used. For example, manual image relighting involves adjusting the lighting settings using photo-editing software. This approach is typically very time-consuming and involves a skilled editor, which provides a substantially full control over the lighting and is often used in commercial photography. Automated image relighting, on the other hand, uses computer vision and machine learning algorithms to adjust the lighting settings automatically. This approach can be much faster and more efficient than manual image relighting, but it may not provide the same level of control over the lighting.

Example steps involved in automated image relighting include:
Image acquisition. This step provides an image or a series of images and can be accomplished with a digital camera or by obtaining images from an external source.
Image preprocessing. The acquired images are preprocessed to remove noise and/or certain artifacts. This step ensures that the image is ready for proper analysis.
Lighting estimation. This step is used to estimate certain parameters of the scene and the lighting conditions of the image and can be performed using a machine learning algorithm that analyzes the image and estimates the illumination settings. For example, albedo, normal, shadow, and lighting can be extracted during this step using an inverse rendering technique.
Relighting. After the lighting conditions are estimated, the image can be relit using a selected lighting model. Different lighting models can be selected, depending on the intended application.
Post-processing. The relit image is typically post-processed to remove the noise and/or certain artifacts that may have been introduced during the relighting step.

Example embodiments disclosed herein focus on the “relighting” portion of the above-outlined automated image relighting process. In some examples, the relighting needs to compensate for the loss of information during the “lighting estimation” step and generate lighting effects under the new lighting conditions. For outdoor scenes, it may be particularly challenging to generate shadows and the sky that are “coherent” to the scene. For example, the boundary of an “incoherently” generated sky may not be fully complementary to the outline of the objects to which the sky serves as a backdrop.

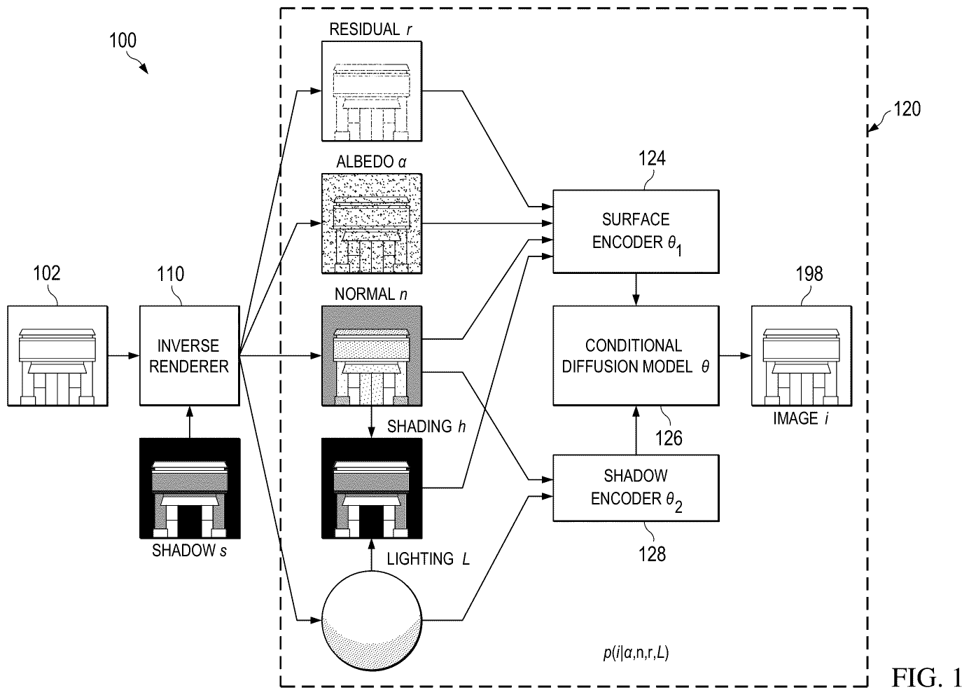

FIG. 1 is a block diagram providing a high-level illustration of an image-relighting pipeline (100) according to an embodiment. An input to the pipeline (100) includes an input image (102). An output of the pipeline (100) includes an output image (198). The pipeline (100) includes an inverse renderer (110) and a model (120). The output channels of the inverse renderer (110) are the shadow s, residual r, albedo α, normal n, and lighting L. The functionality of the model (120) is to provide a light distribution for the output image (198) conditioned on the residual r, albedo α, normal n, and lighting L. Two primary lighting effects are considered: (i) shading, which is the appearance of surfaces under lighting, and (ii) shadow, which is the dark areas caused by blocking of the light.

The model (120) includes a surface encoder (124) configured to extract latent features from the albedo, normal, shading, and residual channels for various lighting effects, except for the shadow. For the shadow effect, the model (120) uses a shadow encoder (128) trained to extract latent features based on the normal and lighting channels. Conditions corresponding to the extracted latent features are applied to a pretrained conditional diffusion model (126), an output of which provides the output image (198).

In one example, the training of the model (120) with two conditions is performed in a stepwise progressive way. First, the surface encoder (124) is trained with a decoder (not explicitly shown in FIG. 1) to render an image without a shadow, and the shadow encoder (128) is trained with another decoder (not explicitly shown in FIG. 1) to generate the shadow. Rendering the shadow-free image and the shadow does not generally guarantee that a coherent image will be generated, especially in the sky region of the output image (198). To address this problem, we train the conditional diffusion model (126), with the surface encoder (124), to render an image without a shadow but with a coherent sky. Next, with both the surface encoder (124) and the shadow encoder (128), the conditional diffusion model (126) is trained to generate a output image (198) with a shadow. In some examples, the pipeline (100) has the following beneficial features:
The conditional diffusion model (126) tends to improve the global coherence of the lighting effects generation compared to some other methods.
The surface encoder (124) and the shadow encoder (128) add conditions to a pretrained diffusion model via a ControlNet mechanism.
The ControlNets are pretrained before training in the stable diffusion pipeline.

The pipeline (100) combines neural rendering and diffusion models. Various pertinent components of these two techniques are described in more detail in the next four (correspondingly titled) sections. We first describe how lighting is represented with spherical harmonics. Then, the rendering function of 2D images and the relighting procedure are defined. Next, we describe the pertinent details of suitable diffusion models from the perspective of generative models. Finally, we discuss the ControlNets, which provide the conditioning mechanism for the diffusion models.

### Lighting and Spherical Harmonics

Lighting from the infinite distance can be formulated as a function ƒ: Φ→ [symbol] ³ from different directions, where, for each direction, ϕ∈Φ, ƒ(ϕ) represents the intensity of three (red, green, and blue; RGB) color channels. Given a lighting function and a surface normal, computing the color using a diffuse surface reflection model uses integration. As an alternative, spherical harmonic coefficients can be used to approximate color distributions for different surface directions on a sphere S. For the lighting function, three respective sets of coefficients are used to represent the RGB color channels.

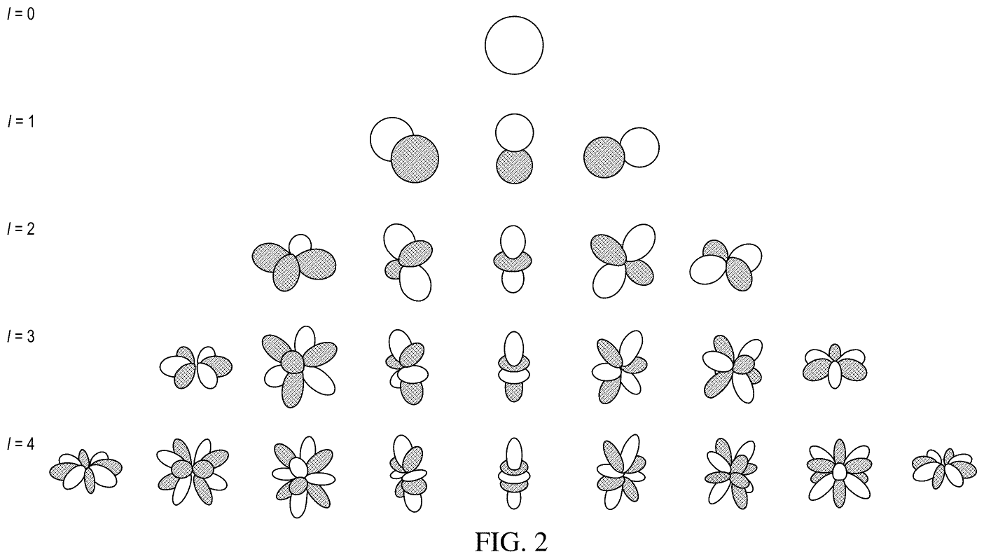

FIG. 2 provides a visual representation of a set of basis functions that can be used to construct an approximation, with spherical harmonics, of the color and distribution of light according to some examples. More specifically, the first five levels (l=0, 1, . . . , 4) of such basis functions (spherical harmonics) are graphically shown in FIG. 2. The two different shades of the lobes represent positive and negative values, respectively.

An approximation with spherical harmonics may have different degrees of precision. For a degree d, (d+1)² orthogonal basis functions y₁, y₂, . . . , y_{(d+1)}_{²} on S are used. Spherical harmonics of the degree d use the basis functions from the level l=0 to the level l=d. The approximated function \tilde{ƒ}(s) is formulated as:

$$\tilde{f} ( s ) = {\sum }_{k = 1}^{{( d + 1 )}^{2}} {c}_{k} {y}_{k} ( s ) \qquad ( 1 )$$

where c₁, c₂, . . . c_{(d+)}_{²}∈R are the coefficients applied to the basis functions. For a given degree d, the basis functions are fixed. As a result, it is possible to represent \tilde{ƒ}(s) with the set of appropriately indexed coefficients. For illustration purposes and without any implied limitations, we assume d=2. For three color channels, the lighting matrix L is represented by three vectors of the length (d+1)²=9.

After one obtains the lighting matrix L, the obtained matrix can be manipulated for relighting purposes. For example, the color of the light can be adjusted by adjusting the relative coefficient values of the RGB color channels. The spatial orientation of the approximated function \tilde{ƒ}(s) can be rotated using appropriate matrix transformation operations.

### Inverse Rendering and Relighting

In order to relight a 2D image, the 3D structure represented by the image needs to be appropriately elucidated. In the following description, we assume that a pixel m that corresponds to an object in the image i can be decomposed as:

$$i ( m ) = s ( m ) α ( m ) ⊙ Lb ( n ( m ) ) \qquad ( 2 )$$

where:
the ⊙ symbol denotes element-wise multiplication,
i(m)∈[0,1]³ represents the color values of the three color channels;
s(m)∈[0,1] is the shadow, which scales down the brightness of certain areas;
α(m)∈[0,1]³ is the albedo, which is the basic color without any lighting effects;
L is the lighting matrix of the shape (3, 9), with the number 3 corresponding to the color channels and the number 9 corresponding to the spherical harmonics described in the previous section;
n(m)∈[−1,1]³ is the normal, which defines the orientation of the corresponding surface; and
b(·): [symbol] ³→ [symbol] ⁹ is a fixed function that converts a normal vector into the values of spherical harmonics basis functions such that Lb(n(m)) is the shading which means how the surface looks like under the lighting condition.

Eq. (2) assumes a one-to-one mapping between the image i and four channels: the shadow s, the albedo α, the lighting L, and the normal n. The procedure used for extracting these four channels from the image is referred to as inverse rendering. In many cases, inverse rendering is an under-defined problem, solving which may involve additional supervision of some or all the four channels. In some examples, inverse rendering can be implemented as described in Yu, Y., and Smith. W. A. (2021), “Outdoor inverse rendering from a single image using multi-view self-supervision,” IEEE Transactions on Pattern Analysis and Machine Intelligence, v. 44(7), pp. 3659-3675, which is incorporated herein by reference in its entirety.

In practice, the inverse rendering is an approximation. Therefore, we introduce a residual term r(m)∈[−1,1]³ to capture the loss of information during the inverse rendering procedure. Accordingly, Eq. (2) is modified to be:

$$i ( m ) = s ( m ) ( α ( m ) ⊙ Lb ( n ( m ) ) + r ( m ) ) \qquad ( 3 )$$

After s, α, L, and n are obtained from the inverse renderer, the residual term is computed as:

$$r ( m ) = \frac{i ( m )}{s ( m )} - α ( m ) ⊙ Lb ( n ( m ) ) \qquad ( 4 )$$

Herein, we assume that the residual term is shadow free, which is a feature compatible with the architecture of our diffusion model. With this residual term, the inverse rendering is formulated as the following function:

$$( s , α , n , r , L ) = IR ( i ) \qquad ( 5 )$$

With the decomposition and an inverse rendering technique, it is possible to edit an image by editing the channels in the decomposition. Under a new lighting condition L′, the new image is represented by:

$${i}^{′} ( m ) = {s}^{′} ( m ) ( α ( m ) ⊙ {L}^{′} b ( n ( m ) ) + r ( m ) ) \qquad ( 6 )$$

In order to render the scene under the new lighting condition, one pertinent task is to generate the new shadow map, s′. It can be assumed that the shadow s′ is a function of the lighting L′ and the normal n. In the pipeline (100), the shadow encoder (128) is designed to control the generation of the shadow in response to the normal and the lighting being given as inputs.

In the above description, we considered pixels in an image that correspond to objects. However, outdoor scene images may also include sky portions. Under the new lighting condition, the original sky may not be coherent to the objects anymore. Therefore, in at least some examples, an additional pipeline that generates the new sky is also included. It should also be noted that the decomposition substantially ignores indirect lighting effects, such as reflectance. In some cases, a shadow network, a sky generative adversarial network (GAN), and a neural renderer are separately trained to perform the relighting task. In various embodiments of the pipeline (100), these three components are unified and replaced with a single conditional diffusion model.

### Latent Diffusion Models

From a probabilistic perspective, the new (relighted) image i′ follows a distribution conditioned on the albedo α, the normal n, the residual r, and the new lighting L′. Therefore, after the conditional distribution p(i|α, n, r, L) is learned, the relighting can be achieved by getting the α, n, r channels from the inverse renderer and then simulating p(i′|α, n, r, L′) with the new lighting L′.

In this section, we first describe how latent diffusion models (LDMs) are trained to model unconditional distributions. We then extend LDMs to conditional distributions.

Suppose that one wants to learn the distribution of an observed variable y. It can be assumed that the distribution ρ(y) is the marginal of a parameterized joint density ρ_{λ}(x, y)=ρ_{λ}(x)ρ_{λ}(y|x), where a latent variable x is introduced. ρ_{λ}(x) and ρ_{λ}(y|x) are two distributions that approximate the data generating procedure of y. However, when one wants to learn the model by maximizing the log likelihood log ρ_{λ}(y), it may be relatively difficult to get ρ_{λ}(y)=∫ρ_{λ}(x, y)dx analytically. Instead, variational inference (VI) can be introduced to approximate the posterior ρ_{λ}(x|y) with a parameterized distribution q_{ϕ}(x|y). With VI, it is possible to obtain the evidence lower bound (ELBO) of log ρ(y) as follows:

$${ℒ}_{E L B O} ( y ; λ , ϕ ) = {𝔼}_{x ∼ q} [ log \frac{{p}_{λ} ( x , y )}{{q}_{ϕ} ( x \vert y )} ] \leq log {p}_{λ} ( y ) \qquad ( 7 )$$

By optimizing the ELBO over the parameters λ and ϕ, the data generating procedure can be learned. In the meantime, the Kullback-Leibler (KL) divergence between q_{ϕ}(x|y) and ρ_{λ}(x|y) is minimized. When the parameters are from neural networks, the corresponding model is typically referred to as the variational auto-encoder (VAE). q_{ϕ}(x|y) is interpreted as an encoder from the data space to the latent space, and ρ_{λ}(y|x) is regarded as a decoder from the latent space to the data space. One building block of the LDM is a vector-quantized variational autoencoder (VQ-VAE), which is a variant of VAE with quantized latent variables. For an image i as the observed variable y, the VQ-VAE includes an encoder x=ε(i) that maps the image to a latent code x with lower dimensionality and a decoder i′= [symbol] (x) that maps the latent code back to the image space. Ideally, i=i′. But in practice, details of the original image may not be fully preserved after going through the encoder and decoder in sequence.

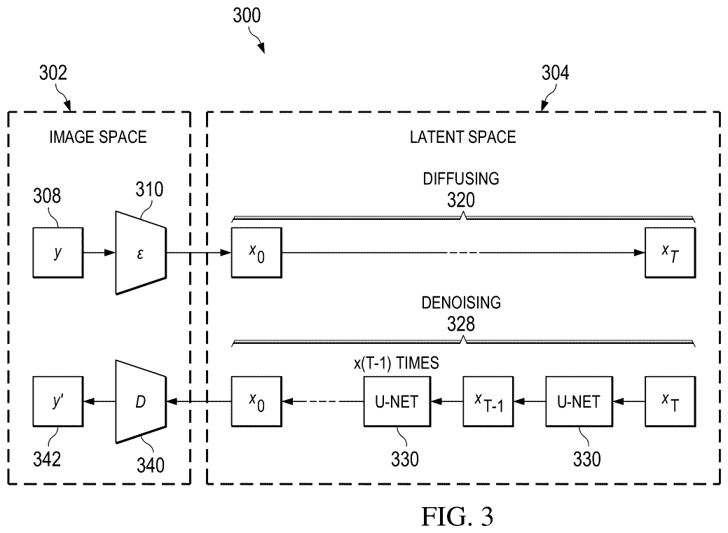

FIG. 3 is a block diagram illustrating a latent diffusion model (300) according to some examples. Therein, y denotes pixel space variables, and x denotes latent space variables. Text embeddings and time embeddings are omitted for better clarity of depiction.

The model (300) includes a VQ-VAE (310) configured to transform an image (308) from an image space (302) to a latent space (304). A diffusing process (320) operates to map the output, x₀, of the VQ-VAE (310) to the latent variable, x_{T}. A denoising process (328), which learns a transition from the distribution of the latent code x to a unit normal distribution. In some examples, an implementation of the denoising process (328) is based on a denoising diffusion probabilistic model (DDPM). In the example shown, the DDPM is implemented using a sequence of denoising decoders (330) approximated by a diffusion process via variational inference. The observed variable is x₀=x, and the latent variables x₁, x₂, . . . , x_{T} are used with the sequence of the denoising decoders (330) as indicated in FIG. 3. A decoder (340) operates to transform the x₀ back to the image space (302), thereby generating an output image (342).

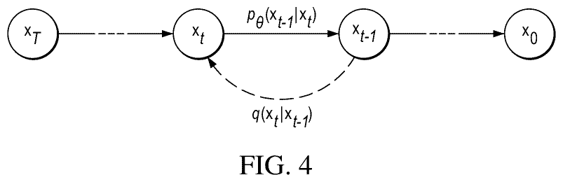

FIG. 4 is a block diagram illustrating the forward diffusing (q(xₜ|xₜ₋₁)) process (320) and the backward denoising (p(xₜ₋₁|xₜ)) process (328) used in the diffusion model (300) according to some examples. The denoising process (328) can be represented as follows:

$$p ( {x}_{0 : T} ) = p ( {x}_{T} ) {\prod }_{t = 1}^{T} p ( {x}_{t - 1} \vert {x}_{t} ) \qquad ( 8 )$$

where ρ(x_{T})= [symbol] (x_{T}; 0, I) and ρ(xₜ₋₁|xₜ)=N(xₜ₋₁; μ_{θ}(xₜ, t), Σ₇₄ (xₜ, t)). An approximate posterior is a fixed forward diffusing procedure that can be represented as follows:

$$q ( {x}_{1 : T} \vert {x}_{0} ) = {\prod }_{t = 1}^{T} q ( {x}_{t} \vert {x}_{t - 1} ) \qquad ( 9 )$$

where q(xₜ|xₜ₋₁)= [symbol] (xₜ; \sqrt{1−βₜ}xₜ₋₁,βₜI) with βₜ to be a constant on t, adding noise to the image step by step.

By maximizing the ELBO of the procedure, the KL divergence between q(x_{1:T}|x₀) and ρ(x_{1:T}|x₀) is minimized, implying that the backward denoising model ρ(x_{0:T}) follows the forward procedure of adding noise. However, directly doing so usually may not be optimal in practice. Another approach is to train a noise prediction network as follows. Since the relationships in the approximate posterior is linear and normal, the following expression can be written:

$${x}_{t} = \sqrt{{\overline{α}}_{t}} {x}_{0} + \sqrt{1 - {\overline{α}}_{t}} ϵ , ϵ ∼ 𝒩 ( 0 , I ) \qquad ( 10 )$$

where αₜ=Π_{τ=1}^{t}(1−βₜ). This means that, given xₜ, the original image can be formulated as:

$${x}_{0} = \frac{{x}_{t} - \sqrt{1 - {\overline{α}}_{t}} ϵ}{\sqrt{{\overline{α}}_{t}}} \qquad ( 11 )$$

If given xₜ, the noise E that leads to it can be predicted perfectly, it is possible to reconstruct the original image x₀. Then, the backward denoising model also follows the forward diffusing model. After properly setting the constants βₜ and the variance functions Σ_{θ}(xₜ, t), the training objective is equivalent to minimizing the noise prediction error:

$${ℒ}_{NOISE} ( θ ) = {𝔼}_{i , {x}_{0} = ℰ ( i )} [ {𝔼}_{t , ϵ} [ {‖ ϵ - {ϵ}_{θ} ( {x}_{t} , t ) ‖}_{2}^{2} ] ] \qquad ( 11 )$$

In this loss function, t is sampled uniformly from 1 to T, and Ee denotes a U-Net (330) that predicts the noise injected to generate xₜ.

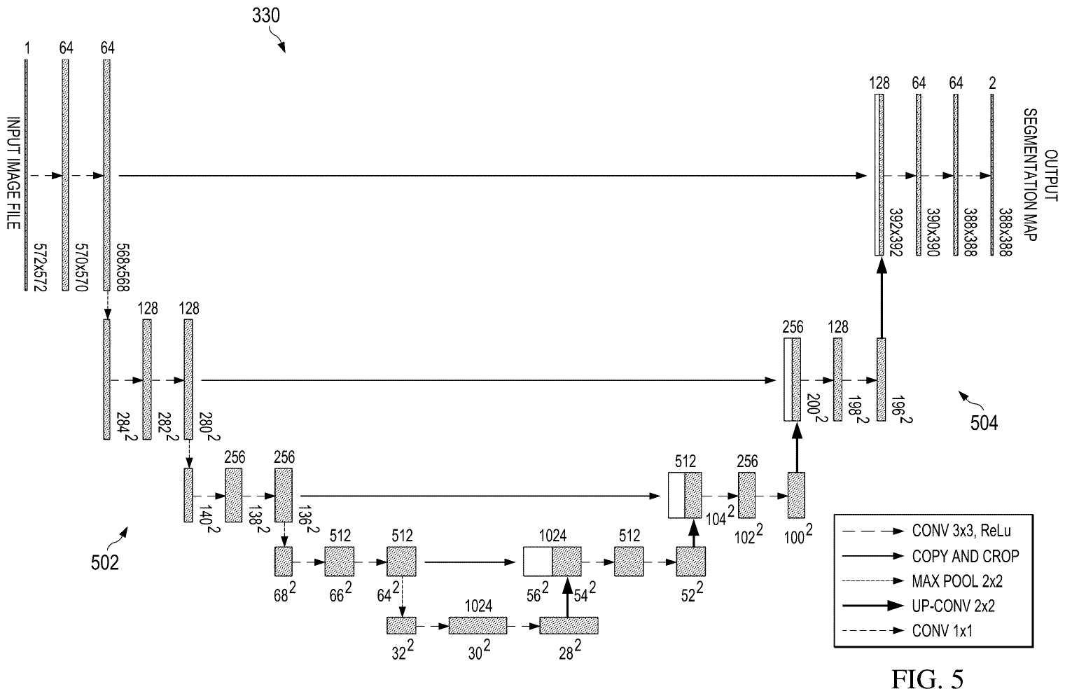

FIG. 5 is a block diagram illustrating an architecture of the U-Net (330) used in the diffusion model (300) according to some examples. In the example shown, the U-Net (330) is a neural network having a U-shaped topology that includes a down-sampling branch (502) and an up-sampling branch (504) connected as indicated in FIG. 5. Skip connections between the branches (502, 504) indicated by the horizontal arrows are added at different scales of the latent features. In some examples, self-attention layers are inserted between convolution layers. In some examples, implementation of the U-Net (330) may benefit from certain features described in Ronneberger, O., Fischer, P., and Brox, T., “U-net: Convolutional networks for biomedical image segmentation,” Medical Image Computing and Computer-Assisted Intervention-MICCAI 2015: 18th International Conference, Munich, Germany, Oct. 5-9, 2015, Proceedings, Part III 18, pp. 234-241, which is incorporated herein by reference in its entirety.

With the above formulation of noise prediction, the denoising model during inference can be expressed as:

$$p ( {x}_{t - 1} \vert {x}_{t} ) = 𝒩 ( {x}_{t - 1} ; \frac{1}{\sqrt{1 - {β}_{t}}} ( {x}_{t} - \frac{{β}_{t}}{\sqrt{1 - {\overline{α}}_{t}}} {ϵ}_{θ} ( {x}_{t} , t ) ) , {β}_{t} I ) \qquad ( 12 )$$

Based on the above formulations, it is possible to train the latent diffusion model (300) for unconditional image generation. More specifically, the VQ-VAE (310) is trained to map image into the latent space (304), and the diffusion model is trained to model the generating procedure of the latent variable. To generate an image, we first sample x_{T}˜ [symbol] (0, I). Then, we obtain x₀ by simulating ρ(x_{T-1}|x_{T}), . . . , ρ(x₀|x₁) in sequence. Finally, the output image (342) is obtained by going through the decoder (340), i= [symbol] (x₀).

### ControlNet Models

An example procedure of learning a conditional distribution ρ(y|z) is described in this section. The joint density with the latent variables x is formulated as ρ(x, y|z)=ρ(x|z)ρ(y|x, z). The above-described formulations still hold after adding z as the condition to some parts of the model. For the generative procedure of the latent diffusion model (300), we assume the condition z is added to a U-Net (330) of the noise prediction network. Thus, the training objective can be expressed with the loss function [symbol] as:

$${ℒ}_{NOISE} ( {x}_{0} ; θ ) = {𝔼}_{t , ϵ} [ {‖ ϵ - {ϵ}_{θ} ( {x}_{t} , t , z ) ‖}_{2}^{2} ] \qquad ( 13 )$$

It may, however, be slow to train a diffusion model from scratch. The stable diffusion model is a publicly available latent diffusion model pretrained on billions of high-quality images. Some embodiments disclosed herein use the ControlNet mechanism to add conditions to the stable diffusion model to enable application of that model to outdoor scene relighting, thereby beneficially abbreviating the training process by taking advantage of the previously performed training.

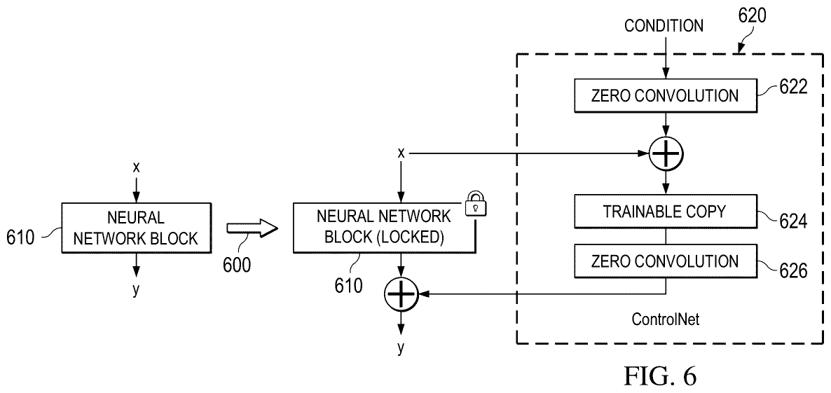

FIG. 6 is a block diagram illustrating a modification (600) used to add a condition to an existing neural network (610) according to some examples. In one example, the neural network (610) represents the above-mentioned stable diffusion model. The modification (600) includes connecting a ControlNet (620) to the neural network (610) as indicated in FIG. 6.

Suppose that we have a parameterized function u= [symbol] (ν; Θ) and that a condition w which has the same shape as ν needs to be added. A ControlNet makes a copy of the parameter Θ_{c} and formulates the output as:

$$u = {ℱ}^{′} ( v , w ; {Θ}_{c} , {Ψ}_{1} , {Ψ}_{2} ) = ℱ ( v ; Θ ) + 𝒵 ( ℱ ( v + 𝒵 ( w ; {Ψ}_{1} ) ; {Θ}_{c} ) ; {Ψ}_{2} ) \qquad ( 14 )$$

where [symbol] (·; Ψ) is a zero-convolution layer, which initializes both the weight and the bias as zeros. The updated function [symbol] is trained over [Θ_{c}, Ψ₁, Ψ₂] while keeping the original parameter Θ fixed. Before training, due to the zero-convolution layers (622, 626), [symbol] is equivalent to [symbol] ignoring the additional condition w. As the training proceeds, the network (622, 624, 626) learns the contribution of w to the output, while keeping the original parameters of the neural network (610) intact. During inference, the same pipeline is executed, using the parameters optimized during the training.

In some cases, it is also possible to add multiple ControlNets to a single function. For example, when two sets of ControlNet parameters [Θ_{c}, Ψ₁, Ψ₂] and [Θ_{c}_{₂}, Ψ₃, Ψ₄] with inputs [w₁, w₂] are introduced, the updated function can be expressed as follows:

$$u = ℱ ( v ; Θ ) + 𝒵 ( ℱ ( v + 𝒵 ( {w}_{1} ; {Ψ}_{1} ) ; {Θ}_{{c}_{1}} ) ; {Ψ}_{2} ) + 𝒵 ( ℱ ( v + 𝒵 ( {w}_{2} ; {Ψ}_{3} ) ; {Θ}_{{c}_{2}} ) ; {Ψ}_{4} ) \qquad ( 15 )$$

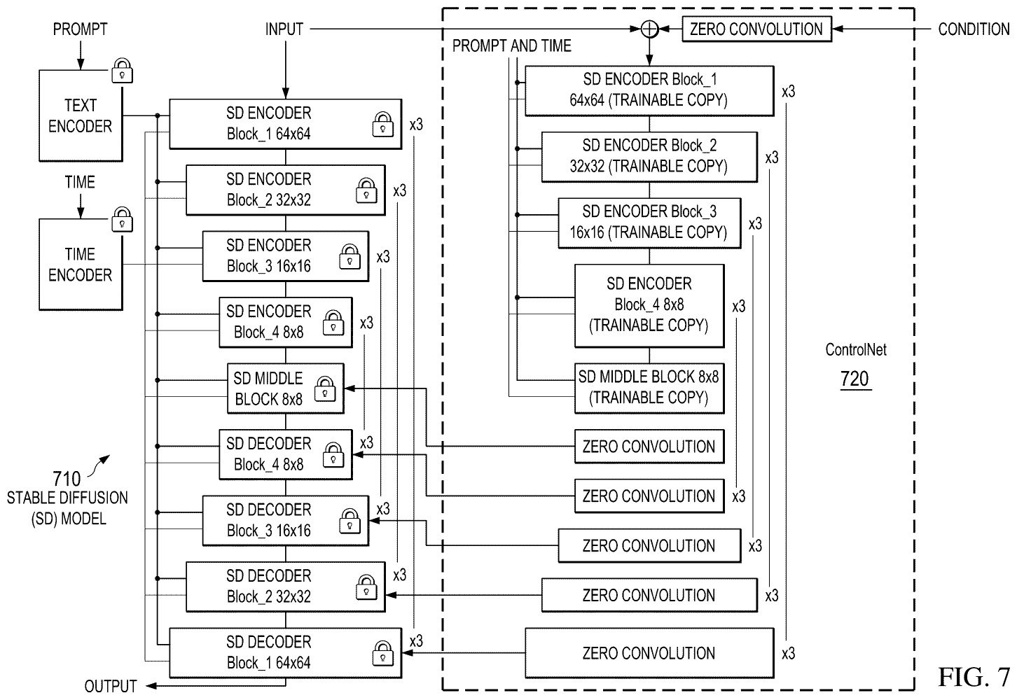

FIG. 7 is a block diagram illustrating the use of a ControlNet (720) for a U-Net that is inside a stable diffusion model (710), according to some examples. More specifically, for the U-Net inside the stable diffusion model, the ControlNets are added by copying the down-sampling blocks and the mid blocks. The input is the feature after the first layer of the U-Net, and the outputs of the down-sampling blocks have different scales. For the copies of the U-Net, the outputs are passed through zero convolution layers and added to the inputs of the fixed upsampling blocks along with the skip connections.

### Outdoor Scene Relighting Pipeline

For outdoor scene relighting, our aim is to learn the distribution ρ(i|α, n, r, L) that follows the following formula in the scene region:

$$i ( m ) = s ( m ) ( α ( m ) Lb ( n ( m ) ) + r ( m ) ) \qquad ( 16 )$$

The learned distribution also needs to have a sky that is coherent to the scene. Two main tasks are shadow generation and sky generation. In some examples, we decompose the simulation of this distribution into two steps:
Rendering an image with the sky but without the shadow; and
Rendering an image with the sky and shadow.

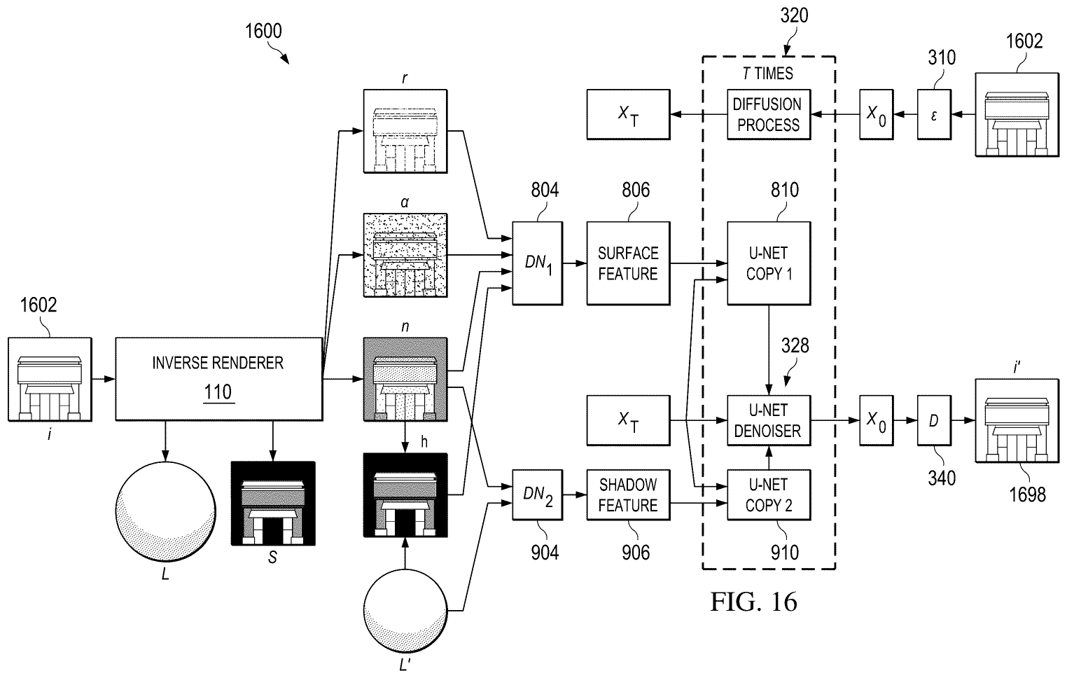

In some examples, these two steps are implemented using two respective ControlNets:
The first ControlNet is used to implement the surface encoder (124) (see FIG. 1). In operation, the ControlNet (124) takes α, n, r and the shading h=Lb(n(m)) as conditions. The pipeline is trained such that, with the surface encoder (124), the diffusion model generates an image with the sky but without the shadow.
The second ControlNet is used to implement the shadow encoder (128). In operation, the ControlNet (128) takes n and L as conditions. It is trained to add the shadow to the generating procedure using the lighting matrix and the surface information.
   The corresponding image-relighting pipeline is further illustrated in FIG. 16. The image-relighting pipeline is configured to follow a procedure according to which the shadow is added on top of the shadow-free image. This procedure may be more intuitively interpretable than a procedure that puts all conditions into a single ControlNet. In addition, separating the sky generation and the shadow generation beneficially enables faster training, e.g., using incremental learning described below.

### Architecture of Encoders

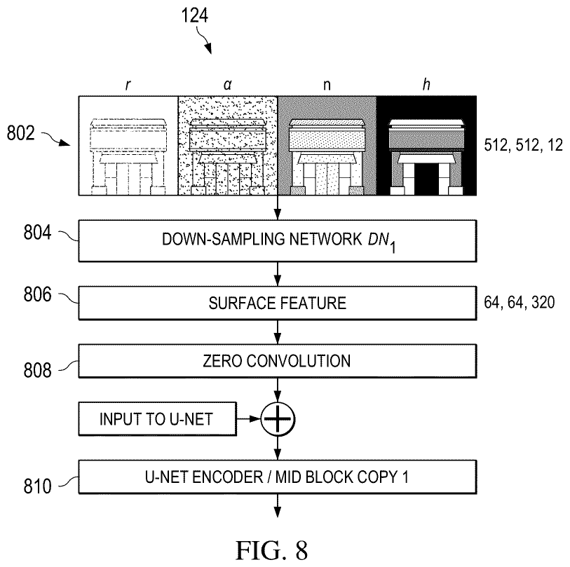

FIG. 8 is a block diagram illustrating the surface encoder (124) according to some examples. A first condition (802), which is applied to the surface encoder (124), is denoted as c₁ and includes four concatenated channels: r, α, n, and h. An example shape of the first condition (802) is (512, 512, 12), where 512×512 is the number of pixels in the corresponding image, and 12 (4×3) represents the total number of color channels in the four concatenated channels r, α, n, and h. In some examples of the stable diffusion model, the shape of the input to the down-sampling blocks in the U-Net may have a different shape, e.g., (64, 64, 320), as indicated in FIG. 8. Accordingly, a down-sampling network DN₁(·) (804) is used to convert the first condition (804) into a surface feature (806) that matches that different size. A corresponding mathematical expression for the surface feature (806) is d₁=DN₁(c₁). The surface feature (806) then acts as a first additional condition to the U-Net, which is represented by a U-Net encoder (810), via the above-described ControlNet mechanism (also see 620, FIG. 6). In the example shown, a zero-convolution layer (808) is functionally analogous to the zero-convolution layer (622) of the ControlNet (620).

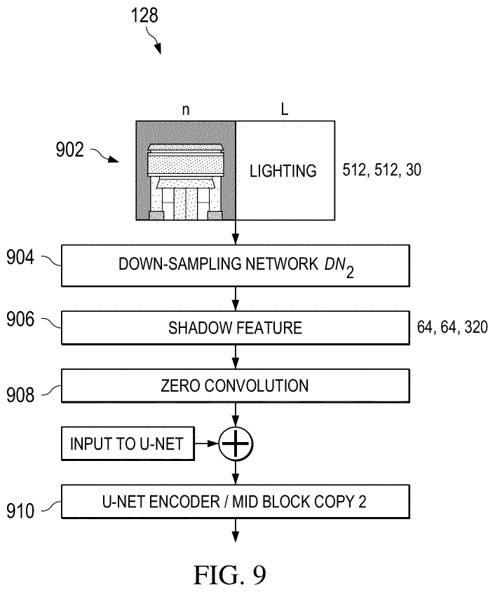

FIG. 9 is a block diagram illustrating the shadow encoder (128) according to some examples. A second condition (902), which is applied to the shadow encoder (128), is denoted as c₂ and includes two concatenated channels: n, L. An example shape of the normal n is (512, 512, 3), where 512×512 is the number of pixels in the corresponding image, and 3 is the number of components of the vector n in the 3D space. An example shape of the lighting L is (9,3). To properly concatenate the n and L channels and form the second condition (902), we reshape the lighting L into a vector and replicate that vector on each pixel, thereby obtaining the matrix of the shape (512, 512, 27). The concatenation operation then produces the shape (512, 512, 30) for the second condition (902). To match the shape of (64, 64, 320), the second condition (902) is processed by a down-sampling network DN₂(·) (904). The output of the down-sampling network (904), d₂=DN₂(c₂), is a shadow feature (906). The shadow feature (906) acts as a second additional condition to the U-Net, which is represented by a U-Net encoder (910), via the above-described ControlNet mechanism, with the ControlNet including a zero-convolution layer (908).

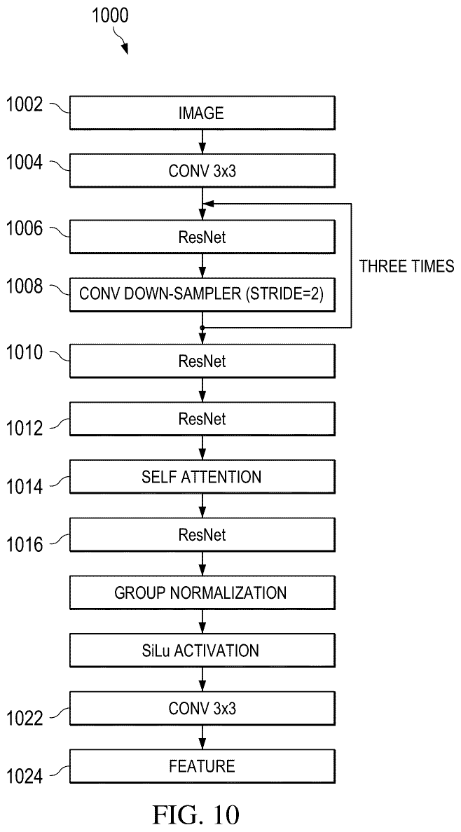

FIG. 10 is a block diagram illustrating an architecture (1000) that can be used to implement the downsampling network (804 or 904) according to some examples. One notable feature of the architecture (1000) is the use of a plurality of ResNets (1006, 1010, 1012, 1016) and a self-attention layer (1014). In some examples, the architectures of the down-sampling networks (1004, 1008) are similar to the encoder E in the VQ-VAE of the stable diffusion model except for the first and last convolution layers (1004, 1022), whose channel numbers are determined by the input and output shapes (1002, 1024). In some examples, the ResNets (1006, 1010, 1012, 1016) may benefit from at least some features disclosed in He, K., Zhang, X., Ren, S., and Sun, J., “Deep residual learning for image recognition,” Proceedings of the IEEE conference on computer vision and pattern recognition, 2016, pp. 770-778, which is incorporated herein by reference in its entirety. In some examples, the self-attention layer (1014) may benefit from at least some features disclosed in Vaswani, A., Shazeer, N., Parmar, N., Uszkoreit, J., Jones, L., Gomez, A. N., et al. “Attention is all you need,” Advances in neural information processing systems, 2017, v. 30, which is incorporated herein by reference in its entirety.

To attach the conditions (802, 902) to the stable diffusion model, for each of the encoders (124, 128), the following components need to be trained:
the down-sampling network (804, 904);
the trainable copy (624) of the U-Net in the stable diffusion model; and
the zero-convolution layers (622, 626) that are designed for the ControlNet mechanism.

### Training

In one example, the training process of the pipeline (100) includes three training stages:
Stage 1: Training of the down-sampling networks (804, 904) along with additional decoders.
Stage 2: Training the stable diffusion model conditioned on the surface encoder (124).
Stage 3: Training the stable diffusion model conditioned on both the surface encoder (124) and the shadow encoder (128).
   These three stages are described in more detail below.

Stage 1 is designed for configuring the output features (806, 906) of the down-sampling networks (804, 904) to contain enough information for rendering. The rendering function of the scene is as follows:

$$i ( m ) = s ( m ) ( α ( m ) ⊙ Lb ( n ( m ) ) + r ( m ) ) = s ( m ) f ( m ) \qquad ( 17 )$$

The output of this rendering function can be decomposed into a shadow map s and a shadow-free image ƒ.

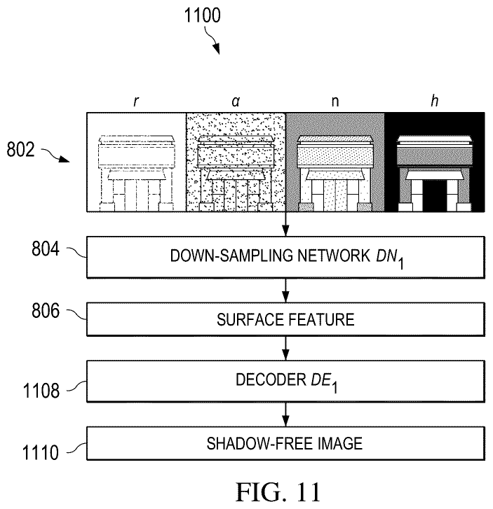

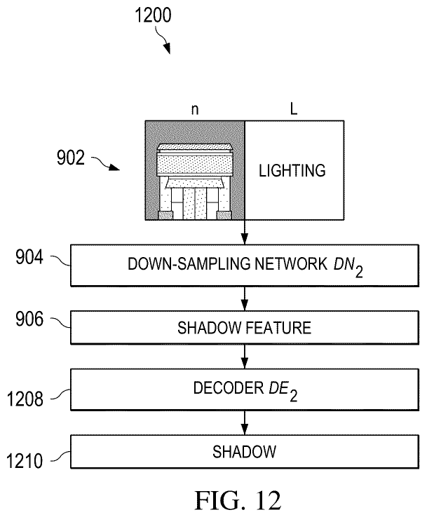

FIGS. 11-12 are block diagrams illustrating computation flows (1100, 1200) for training the surface encoder (124) and the shadow encoder (128), respectively, at Stage 1 of the training process according to some examples. The down-sampling network DN₁ (804) of the surface encoder (124) is trained with an up-sampling decoder DE₁ (1108) to render a shadow-free image ƒ (1110). The down-sampling network DN₂ (904) of the shadow encoder (128) is trained with an up-sampling decoder DE₂ (1208) to generate a shadow map s (1210).

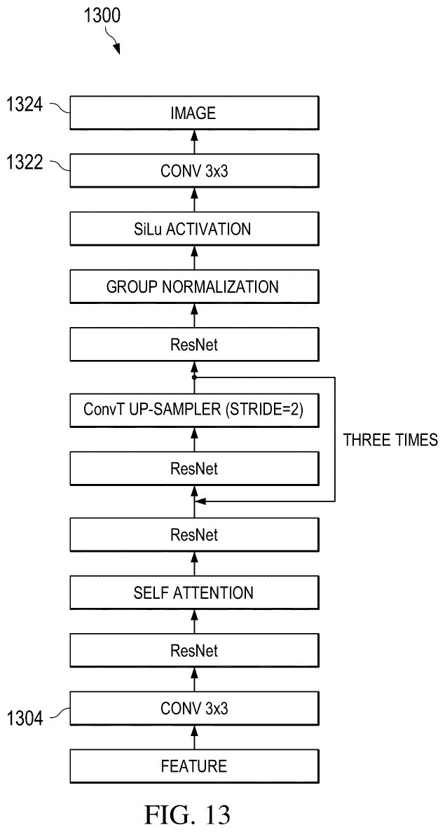

FIG. 13 is a block diagram illustrating an architecture (1300) of the upsampling decoder (1108, 1208) according to some examples. The architecture (1300) of the decoders (1108, 1208) is similar to the decoder D in the VQ-VAE of the stable diffusion model except that the first and last convolution layers (1304, 1322), which are designed to be compatible with the above-described architectures of the down-sampling networks (804, 904).

The parameters in the networks are trained by minimizing the mean-squared-error (MSE) between the outputs (1324) and the corresponding reference ground-truths obtained with the inverse renderer (110). In some examples, the loss functions are formulated as follows:

$${ℒ}_{1} = {𝔼}_{i} [ \frac{1}{512 \times 512 \times 3} {‖ f - D {E}_{1} ( D {N}_{1} ( {c}_{1} ) ) ‖}_{2}^{2} ] \qquad ( 18 )$$

$${ℒ}_{2} = {𝔼}_{i} [ \frac{1}{512 \times 512} {‖ s - D {E}_{2} ( D {N}_{2} ( {c}_{2} ) ) ‖}_{2}^{2} ] \qquad ( 19 )$$

The loss function [symbol] ₁ is used for training DN₁ along with DE₁, which enables DN₁ to convert the condition c₁ into the surface feature (806). Similarly, the loss function [symbol] ₂ is used to make DN₂ convert the condition c₂ into the shadow feature (906).

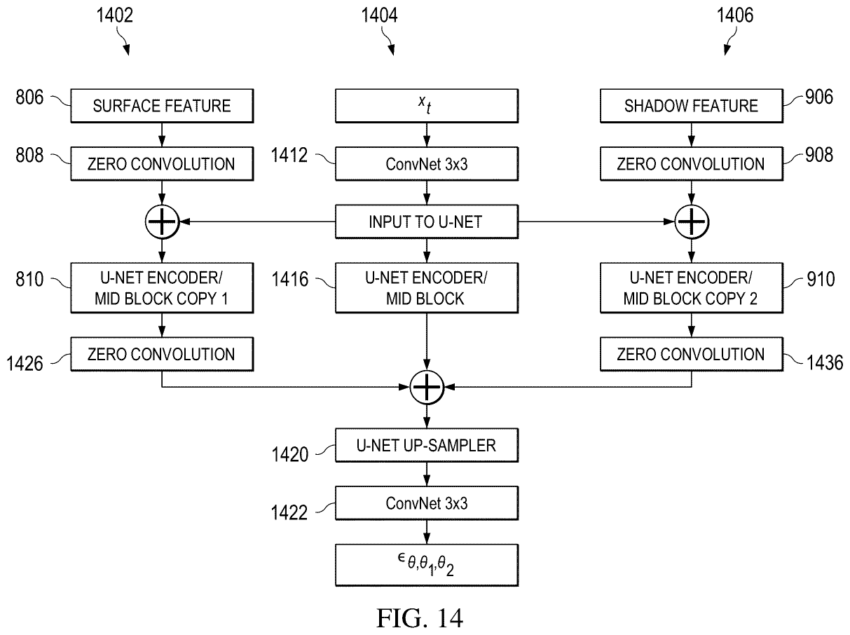

FIG. 14 is a block diagram illustrating an architecture (1400) for training the surface encoder (124) at Stages 2 and 3 of the training process according to some examples. The architecture (1400) includes a U-Net (1404) of the stable diffusion model and two ControlNets (1402, 1406) connected thereto as indicated in FIG. 14. The time encoder and the text encoder of the stable diffusion model are not explicitly shown in FIG. 14 for the sake of better clarity. The blocks (1412, 1416, 1420, 1422) of the U-Net (1404) are locked. The blocks (808, 810, 1426) of the ControlNet (1402) are trained at Stages 2 and 3. The blocks (908, 910, 1436) of the ControlNet (1406) are trained at Stage 3.

After Stage 1 of the training process is completed, outputs from the encoders (124, 128) are attached to the existing U-Net (1404) in the stable diffusion model as indicated in FIG. 14. At Stage 2 of the training process, the parameters in the surface encoder θ₁ (124), including the down-sampling network (804), zero-convolution layers (808, 1426), and the U-Net copy (810) are trained by minimizing the noise prediction error conditioned on c₁. In some examples, the following loss function, [symbol] _{SURFACE} (θ₁), is used for this purpose:

$${ℒ}_{SURFACE} ( {θ}_{1} ) = {𝔼}_{i , {x}_{0} = ℰ ( i )} [ {𝔼}_{t , ϵ} [ {‖ ϵ - {ϵ}_{{θ}_{1}} ( {x}_{t} , t , {DN}_{1} ( {c}_{1} ) ) ‖}_{2}^{2} ] ] \qquad ( 20 )$$

After Stage 2 of the training process is completed, the conditional diffusion model has learned to generate an image with the sky but without the shadow. Then, at Stage 3, the shadow is added to the generated image by optimizing the parameters in the shadow encoder (128), θ₂, with the noise prediction loss conditioned on c₁ and c₂. In some examples, the following loss function, [symbol] _{SHADOW}(θ₂), is used for this purpose:

$${ℒ}_{SHADOW} ( {θ}_{2} ) = {𝔼}_{i , {x}_{0} = ℰ ( i )} [ {𝔼}_{t , ϵ} [ {‖ ϵ - {ϵ}_{{θ}_{2}} ( {x}_{t} , t , {DN}_{1} ( {c}_{1} ) , {DN}_{2} ( {c}_{2} ) ) ‖}_{2}^{2} ] ] \qquad ( 21 )$$

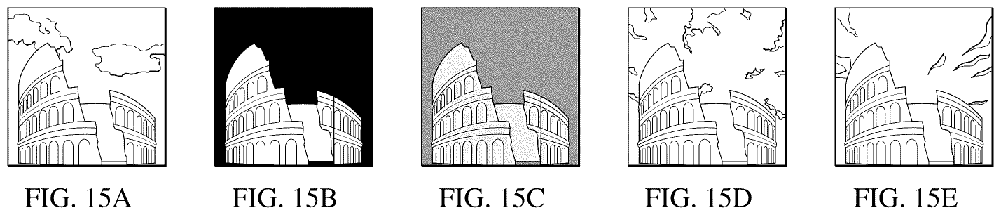

FIGS. 15A-15E pictorially illustrate the above-described three-stage training procedure for the pipeline (100) according to one example. More specifically, FIG. 15A shows an example original image. FIG. 15B shows a shadow-free image rendering with DN₁ (804) and DE₁ (1108). FIG. 15C shows a shadow rendering with DN₂ (904) and DE₂ (1208). FIG. 15D shows a shadow-free image rendering with the surface encoder (124) and the stable diffusion model at Stage 2. FIG. 15E shows an image rendering with both encoders (124, 128) and the stable diffusion model at Stage 3.

### Relighting Procedure

FIG. 16 is a block diagram illustrating a relighting pipeline (1600) according to some examples. Inputs to the relighting pipeline (1600) include an input image (1602) and a new lighting condition L′. The blocks (804, 904, 810, 910) are trained as described above. The diffusing process (320), the denoising process (328), the encoder (310), and the decoder (340) are the pretrained components of the stable diffusion model that are locked (i.e., do not undergo any additional training).

In some examples, to perform relighting of the 2D image i (1602) under the new lighting condition L′, the relighting pipeline (1600) executes the following operations:
Extracting information by utilizing an existing sky segmentation pipeline and the inverse renderer (110) as (s, α, n,r, L)=IR (i);
Obtaining the shading h based on the formula h=Lb(n(m));
Forming the condition c₁(802) by properly concatenating the α, n, r, h channels;
Converting the condition c₁(802) into the surface feature (806) using the downsampling network (804), as d₁=DN₁(c₁);
Forming the condition c₂ (902) by reshaping L′ into a vector, expanding on each pixel, and concatenating with n;
Converting the condition c₂ (902) into the shadow feature (906) using the downsampling network (904), as d₂=DN₂(c₂);
Sampling x_{T}˜ [symbol] (0, I) generated via the diffusing process (320);
Simulating ρ(xₜ₋₁|xₜ) until x₀ is obtained using the denoising process (328) with the ControlNet mechanism to which the surface feature d₁(806) and the shadow feature d₂ (906) are applied via the U-Nets (810, 910), as ϵ_{θ, θ}_{₁}_{, θ}_{₂}(xₜ, t, d₁, d₂); and
Converting latent space image x₀ into the pixel space image (1698) by passing x₀ through the decoder (340), as i′= [symbol] (x₀).

### Additional Embodiments

In various additional examples, one or more of the following features and/or modifications can be implemented.

In some examples, instead of training in three stages, one can also train both surface and shadow ControlNets in a single stage, with the conditions being applied together. In some examples, all conditions can be concatenated together and feed into a single ControlNet. The latter modification may lose the intuitive interpretability resulting from the separate surface and shadow encoders but may be as effective for the task of relighting.

In general, generative models, including diffusion models, have a huge collection of variants. The above-described stable diffusion model is just one of such variants. In some examples, other variants, such as an image-space diffusion model, can similarly be used for the relighting pipeline.

The ControlNet mechanism is only one of the possible ways to add conditions to a stable diffusion model. In some additional examples, it is possible to define classifier-based guidance to convert an unconditional diffusion model to a conditional diffusion model without any training. A downside of such approach may be that the inference speed may likely be slower. Another option is to use cross-attention to add conditions to the existing U-Net of the stable diffusion model. This option involves additional training of the U-Net of the stable diffusion model, which may be less straightforward in practice than the ControlNet approach.

The above-described training process assumes that the time t is sampled uniformly from 1 . . . T for simplicity. For other settings of βₜ, different weights are assigned to the noise prediction error at different times t in the loss function. In practice, noise prediction at low t is harder than at high t. As a result, the training procedure may be improved by considering different hyper-parameters, with the purpose of improving the pipeline performance.

In some examples, alternatives to DDPM may be used during the inference stage of the conditional diffusion model. With the noise prediction U-Net, the total number of timesteps T can be adjusted for inference. If T follows the setting of training, the pipeline generates an image faithful to the training set. If T is set to a lower integer, the inference time will be reduced, but the quality of image may be lower. There are several possible directions to get better results with a lower T. For example, one is to choose sampling algorithms other than DDPM and tune the hyperparameters in order to generate an image with better details. Another one is to train a distilled model that works better for lower T from the trained U-Net.

Another task that is closely related to relighting is a view change. Other than manipulating the lighting condition, one may also be interested in changing the position of the camera and re-render the scene image. One technique is to construct a relightable NeRF. However, diffusion models may be helpful in the NeRF generation. As such, a conditional diffusion model can be utilized to construct a relightable NeRF that can edit both the camera position and the lighting condition in the image.

### Example Hardware

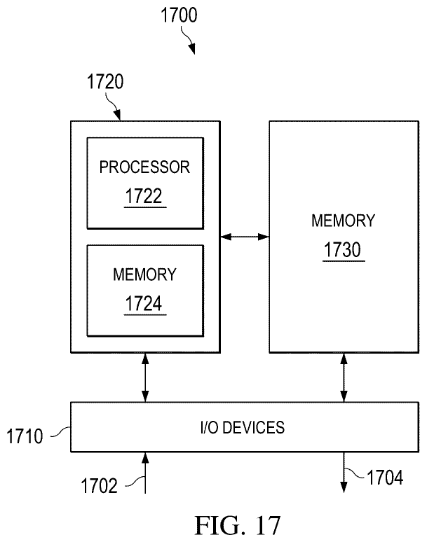

FIG. 17 is a block diagram illustrating a computing device (1700) used to implement the relighting pipeline (1600) according to some examples. The computing device (1700) comprises input/output (I/O) devices (1710), a processing engine (1720), and a memory (1730). The I/O devices (1710) may be used to enable the device (1700) to receive various input signals (1702) and to output various output signals (1704). The memory (1730) may have buffers to receive data. Once the data are received, the memory (1730) may provide parts of the data to the processing engine (1720) for processing therein. The processing engine (1720) includes a processor (1722) and a memory (1724). The memory (1724) may store therein program code, which when executed by the processor (1722) enables the processing engine (1720) to perform processing operations, including but not limited to at least some operations of described above in reference to various components relighting pipeline (1600) and the training procedures.

According to an example embodiment disclosed above, e.g., in the summary section and/or in reference to any one or any combination of some or all of FIGS. 1-17, provided is an image-relighting method comprising: extracting a plurality of channels by applying inverse rendering to an input image, the plurality of channels including an original lighting channel; with a first neural network, determining a first latent feature corresponding to the input image based on a replacement lighting channel and further based on a first subset of the plurality of channels not including the original lighting channel; with a second neural network, determining a second latent feature corresponding to the input image based on the replacement lighting channel and further based on a second subset of the plurality of channels not including the original lighting channel; and generating a relighted image by propagating samples of a latent image map corresponding to the input image through a conditional diffusion model to which the first and second latent features are applied as first and second conditions, respectively, the conditional diffusion model being implemented using a plurality of neural networks.

In some embodiments of the above method, he first subset includes an albedo channel, a normal channel, and a residual channel; and wherein the second subset includes the normal channel.

In some embodiments of any of the above methods, the method further comprises constructing a shading channel based on the normal channel and the replacement lighting channel, wherein the determining of the first latent feature is further based on the shading channel.

In some embodiments of any of the above methods, the conditional diffusion model includes: a first neural network representing a denoising process of a stable diffusion model and including a chain of first convolutional networks; and a control mechanism attached to the first neural network and configured to alter respective outputs of the first convolutional networks based on the first and second conditions.

In some embodiments of any of the above methods, each of the first convolutional networks includes a respective first U-Net encoder and a respective U-Net up-sampler serially connected to one another.

In some embodiments of any of the above methods, the control mechanism includes a plurality of second U-Net encoders, each of the second U-Net encoders being connected in parallel with the respective first U-Net encoder and being responsive to first condition.

In some embodiments of any of the above methods, an input to the respective first U-Net encoder is also applied to the respective one of the second U-Net encoders and a respective one of the third U-Net encoders; and wherein an output to the respective first U-Net encoder is modified using an output of the respective one of the second U-Net encoders and an output of the respective one of the third U-Net encoders.

In some embodiments of any of the above methods, each of the first, second, and third U-Net encoders includes a respective downsampling branch, a respective upsampling branch, and a plurality of skip connections between the respective downsampling and upsampling branches, each of the skip connections corresponding to a different respective scale of latent features.

In some embodiments of any of the above methods, the conditional diffusion model includes a second neural network representing a diffusing process of the stable diffusion model and configured to generate the latent image map corresponding to the input image.

In some embodiments of any of the above methods, each of the original lighting channel and the replacement lighting channel is represented with spherical harmonics.

In some embodiments of any of the above methods, said generating the relighted image comprises: rendering a first version of the relighted image with a sky but without a shadow; and rendering a second version of the relighted image with the sky and the shadow.

According to another example embodiment disclosed above, e.g., in the summary section and/or in reference to any one or any combination of some or all of FIGS. 1-17, provided is a training method comprising: extracting a plurality of channels by applying inverse rendering to an input image, the plurality of channels including a lighting channel; training a first neural network with a first decoder to determine a first latent feature corresponding to the input image based on a first subset of the plurality of channels not including the lighting channel; training a second neural network with a second decoder to determine a second latent feature corresponding to the input image based on a second subset of the plurality of channels including the lighting channel; training a conditional diffusion model to generate an output image by propagating therethrough samples of a latent image map corresponding to the input image with only a first condition being applied to the conditional diffusion model, the first condition being the first latent feature, the conditional diffusion model being implemented using a plurality of neural networks; and training the conditional diffusion model to generate the output image by propagating therethrough the samples of the latent image map corresponding to the input image with both the first condition and a second condition being applied thereto, the second condition being the second latent feature.

In some embodiments of the above method, the first subset includes an albedo channel, a normal channel, and a residual channel; and wherein the second subset includes the normal channel.

In some embodiments of any of the above methods, the method further comprises constructing a shading channel based on the normal channel and the lighting channel, wherein the determining of the first latent feature is further based on the shading channel.

In some embodiments of any of the above methods, the conditional diffusion model includes: a first neural network representing a denoising process of a stable diffusion model and including a chain of first convolutional networks; and a control mechanism attached to the first neural network and configured to alter respective outputs of the first convolutional networks based on the first and second conditions.

In some embodiments of any of the above methods, each of the first convolutional networks includes a respective first U-Net encoder and a respective U-Net up-sampler serially connected to one another.

In some embodiments of any of the above methods, the control mechanism includes a plurality of second U-Net encoders, each of the second U-Net encoders being connected in parallel with the respective first U-Net encoder and being responsive to first condition.

In some embodiments of any of the above methods, the control mechanism includes a plurality of third U-Net encoders, each of the third U-Net encoders being connected in parallel with the respective first U-Net encoder and a respective one of the second U-Net encoders and being responsive to the second condition.

In some embodiments of any of the above methods, an input to the respective first U-Net encoder is also applied to the respective one of the second U-Net encoders and a respective one of the third U-Net encoders; and wherein an output to the respective first U-Net encoder is modified using an output of the respective one of the second U-Net encoders and an output of the respective one of the third U-Net encoders.

In some embodiments of any of the above methods, each of the first, second, and third U-Net encoders includes a respective downsampling branch, a respective upsampling branch, and a plurality of skip connections between the respective downsampling and upsampling branches, each of the skip connections corresponding to a different respective scale of latent features.

In some embodiments of any of the above methods, the conditional diffusion model includes a second neural network representing a diffusing process of the stable diffusion model and configured to generate the latent image map corresponding to the input image.

In some embodiments of any of the above methods, the lighting channel is represented with spherical harmonics.

According to yet another example embodiment disclosed above, e.g., in the summary section and/or in reference to any one or any combination of some or all of FIGS. 1-17, provided is An image-relighting method, comprising: extracting a plurality of channels by applying inverse rendering to an input image, the plurality of channels including an original lighting channel; with a first neural network, determining a first latent feature corresponding to the input image based on a replacement lighting channel and further based on a first subset of the plurality of channels not including the original lighting channel; and generating a relighted image by propagating samples of a latent image map corresponding to the input image through a conditional diffusion model to which the first latent feature is applied as a first condition, the conditional diffusion model being implemented using a plurality of neural networks.

In some embodiments of the above method, the method further comprises, with a second neural network, determining a second latent feature corresponding to the input image based on the replacement lighting channel and further based on a second subset of the plurality of channels not including the original lighting channel, wherein the second latent feature is applied to the conditional diffusion model as a second condition.

In some embodiments of any of the above methods, the method further comprises, with a third neural network, determining a third latent feature corresponding to the input image based on a third subset of the plurality of channels not including the original lighting channel, wherein the third latent feature is applied to the conditional diffusion model as a third condition.

In some embodiments of any of the above methods, the first subset includes an albedo channel, a normal channel, and a residual channel; and wherein the second subset includes the normal channel.

In some embodiments of any of the above methods, the method further comprises constructing a shading channel based on the normal channel and the replacement lighting channel, wherein the determining of the first latent feature is further based on the shading channel.

According to yet another example embodiment disclosed above, e.g., in the summary section and/or in reference to any one or any combination of some or all of FIGS. 1-17, provided is a non-transitory computer-readable medium storing instructions that, when executed by an electronic processor, cause the electronic processor to perform operations comprising any one of the above methods.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments incorporate more features than are expressly recited in each claim. Rather, as the following claims reflect, inventive subject matter lies in fewer than all features of a single disclosed embodiment. Thus, the following claims are hereby incorporated into the Detailed Description, with each claim standing on its own as a separately claimed subject matter.

While this disclosure includes references to illustrative embodiments, this specification is not intended to be construed in a limiting sense. Various modifications of the described embodiments, as well as other embodiments within the scope of the disclosure, which are apparent to persons skilled in the art to which the disclosure pertains are deemed to lie within the principle and scope of the disclosure, e.g., as expressed in the following claims.

Some embodiments may be implemented as circuit-based processes, including possible implementation on a single integrated circuit.

Some embodiments can be embodied in the form of methods and apparatuses for practicing those methods. Some embodiments can also be embodied in the form of program code recorded in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing the patented invention(s). Some embodiments can also be embodied in the form of program code, for example, stored in a non-transitory machine-readable storage medium including being loaded into and/or executed by a machine, wherein, when the program code is loaded into and executed by a machine, such as a computer or a processor, the machine becomes an apparatus for practicing the patented invention(s). When implemented on a general-purpose processor, the program code segments combine with the processor to provide a unique device that operates analogously to specific logic circuits.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Unless otherwise specified herein, in addition to its plain meaning, the conjunction “if” may also or alternatively be construed to mean “when” or “upon” or “in response to determining” or “in response to detecting,” which construal may depend on the corresponding specific context. For example, the phrase “if it is determined” or “if [a stated condition] is detected” may be construed to mean “upon determining” or “in response to determining” or “upon detecting [the stated condition or event]” or “in response to detecting [the stated condition or event].”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term compatible means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

The functions of the various elements shown in the figures, including any functional blocks labeled as “processors” and/or “controllers,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

As used in this application, the terms “circuit,” “circuitry” may refer to one or more or all of the following: (a) hardware-only circuit implementations (such as implementations in only analog and/or digital circuitry); (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

“BRIEF SUMMARY OF SOME SPECIFIC EMBODIMENTS” in this specification is intended to introduce some example embodiments, with additional embodiments being described in “DETAILED DESCRIPTION” and/or in reference to one or more drawings. “BRIEF SUMMARY OF SOME SPECIFIC EMBODIMENTS” is not intended to identify essential elements or features of the claimed subject matter, nor is it intended to limit the scope of the claimed subject matter.

What is claimed is:

1. An image-relighting method, comprising:
extracting a plurality of channels by applying inverse rendering to an input image, the plurality of channels including an original lighting channel;
with a first neural network, determining a first latent feature corresponding to the input image based on a replacement lighting channel and further based on a first subset of the plurality of channels not including the original lighting channel;
with a second neural network, determining a second latent feature corresponding to the input image based on the replacement lighting channel and further based on a second subset of the plurality of channels not including the original lighting channel; and
generating a relighted image by propagating samples of a latent image map corresponding to the input image through a conditional diffusion model to which the first and second latent features are applied as first and second conditions, respectively, the conditional diffusion model being implemented using a plurality of neural networks.

2. The method of claim 1,
wherein the first subset includes an albedo channel, a normal channel, and a residual channel; and
wherein the second subset includes the normal channel.

3. The method of claim 2, further comprising constructing a shading channel based on the normal channel and the replacement lighting channel,
wherein the determining of the first latent feature is further based on the shading channel.

4. The method of claim 1, wherein the conditional diffusion model includes:
a third neural network representing a denoising process of a stable diffusion model and including a chain of first convolutional networks; and
a control mechanism attached to the third neural network and configured to alter respective outputs of the first convolutional networks based on the first and second conditions.

5. The method of claim 4, wherein each of the first convolutional networks includes a respective first U-Net encoder and a respective U-Net up-sampler serially connected to one another.

6. The method of claim 5, wherein the control mechanism includes a plurality of second U-Net encoders, each of the second U-Net encoders being connected in parallel with the respective first U-Net encoder and being responsive to first condition.

7. The method of claim 6, wherein the control mechanism includes a plurality of third U-Net encoders, each of the third U-Net encoders being connected in parallel with the respective first U-Net encoder and a respective one of the second U-Net encoders and being responsive to the second condition.

8. The method of claim 7,
wherein an input to the respective first U-Net encoder is also applied to the respective one of the second U-Net encoders and a respective one of the third U-Net encoders; and
wherein an output to the respective first U-Net encoder is modified using an output of the respective one of the second U-Net encoders and an output of the respective one of the third U-Net encoders.

9. The method of claim 7, wherein each of the first, second, and third U-Net encoders includes a respective downsampling branch, a respective upsampling branch, and a plurality of skip connections between the respective downsampling and upsampling branches, each of the skip connections corresponding to a different respective scale of latent features.

10. The method of claim 4, wherein the conditional diffusion model includes a fourth neural network representing a diffusing process of the stable diffusion model and configured to generate the latent image map corresponding to the input image.

11. The method of claim 1, wherein the conditional diffusion model is configured to an input into which the first and second latent features are concatenated.

12. The method of claim 1, wherein each of the original lighting channel and the replacement lighting channel is represented with spherical harmonics.

13. The method of claim 1, wherein said generating the relighted image comprises:
rendering a first version of the relighted image with a sky but without a shadow; and
rendering a second version of the relighted image with the sky and the shadow.

14. A non-transitory computer-readable medium storing instructions that, when executed by an electronic processor, cause the electronic processor to perform operations comprising the method of claim 1.

15. A training method, comprising:
extracting a plurality of channels by applying inverse rendering to an input image, the plurality of channels including a lighting channel;
training a first neural network with a first decoder to determine a first latent feature corresponding to the input image based on a first subset of the plurality of channels not including the lighting channel;
training a second neural network with a second decoder to determine a second latent feature corresponding to the input image based on a second subset of the plurality of channels including the lighting channel;
training a conditional diffusion model to generate an output image by propagating therethrough samples of a latent image map corresponding to the input image with only a first condition being applied to the conditional diffusion model, the first condition being the first latent feature, the conditional diffusion model being implemented using a plurality of neural networks; and
training the conditional diffusion model to generate the output image by propagating therethrough the samples of the latent image map corresponding to the input image with both the first condition and a second condition being applied thereto, the second condition being the second latent feature.

16. The method of claim 15,
wherein the first subset includes an albedo channel, a normal channel, and a residual channel; and
wherein the second subset includes the normal channel.

17. The method of claim 16, further comprising constructing a shading channel based on the normal channel and the lighting channel,
wherein the determining of the first latent feature is further based on the shading channel.

18. The method of claim 15, wherein the conditional diffusion model includes:
a third neural network representing a denoising process of a stable diffusion model and including a chain of first convolutional networks; and
a control mechanism attached to the third neural network and configured to alter respective outputs of the first convolutional networks based on the first and second conditions.

19. The method of claim 18, wherein each of the first convolutional networks includes a respective first U-Net encoder and a respective U-Net up-sampler serially connected to one another.

20. The method of claim 19, wherein the control mechanism includes a plurality of second U-Net encoders, each of the second U-Net encoders being connected in parallel with the respective first U-Net encoder and being responsive to first condition.

21. The method of claim 20, wherein the control mechanism includes a plurality of third U-Net encoders, each of the third U-Net encoders being connected in parallel with the respective first U-Net encoder and a respective one of the second U-Net encoders and being responsive to the second condition.

22. The method of claim 21,
wherein an input to the respective first U-Net encoder is also applied to the respective one of the second U-Net encoders and a respective one of the third U-Net encoders; and
wherein an output to the respective first U-Net encoder is modified using an output of the respective one of the second U-Net encoders and an output of the respective one of the third U-Net encoders.

23. The method of claim 22, wherein each of the first, second, and third U-Net encoders includes a respective downsampling branch, a respective upsampling branch, and a plurality of skip connections between the respective downsampling and upsampling branches, each of the skip connections corresponding to a different respective scale of latent features.

24. The method of claim 18, wherein the conditional diffusion model includes a fourth neural network representing a diffusing process of the stable diffusion model and configured to generate the latent image map corresponding to the input image.

25. The method of claim 13, wherein the lighting channel is represented with spherical harmonics.

26. A non-transitory computer-readable medium storing instructions that, when executed by an electronic processor, cause the electronic processor to perform operations comprising the method of claim 15.

27. An image-relighting method, comprising:
extracting a plurality of channels by applying inverse rendering to an input image, the plurality of channels including an original lighting channel;
with a first neural network, determining a first latent feature corresponding to the input image based on a replacement lighting channel and further based on a first subset of the plurality of channels not including the original lighting channel; and
generating a relighted image by propagating samples of a latent image map corresponding to the input image through a conditional diffusion model to which the first latent feature is applied as a first condition, the conditional diffusion model being implemented using a plurality of neural networks.

28. The method of claim 27, further comprising:
with a second neural network, determining a second latent feature corresponding to the input image based on the replacement lighting channel and further based on a second subset of the plurality of channels not including the original lighting channel,
wherein the second latent feature is applied to the conditional diffusion model as a second condition.

29. The method of claim 28, further comprising:
with a third neural network, determining a third latent feature corresponding to the input image based on a third subset of the plurality of channels not including the original lighting channel,
wherein the third latent feature is applied to the conditional diffusion model as a third condition.

30. The method of claim 28,
wherein the first subset includes an albedo channel, a normal channel, and a residual channel; and
wherein the second subset includes the normal channel.

31. The method of claim 30, further comprising constructing a shading channel based on the normal channel and the replacement lighting channel,
wherein the determining of the first latent feature is further based on the shading channel.
